(19) United States
(12) Patent Application Publication
(10) Pub. No.: US 2007/0298319 A1
(43) Pub. Date: Dec. 27, 2007

(54) UNINTERRUPTABLE BATTERY HOLDER

(76) Inventor: MORRIS LUCIAN BARWICK, Greenville, TX (US)

Correspondence Address: MORRIS L. BARWICK, 5113 F M 2101, GREENVILLE, TX, 75402, US

(21) Appl. No.: 11/771,089

(22) Filed: Jun. 29, 2007

Related U.S. Application Data
(63) Continuation-in-part of application No. 11/472,932, filed on Jun. 22, 2006.

(51) Int. Cl. H01M 2/10

(52) U.S. Cl. 429/100

(57) ABSTRACT

A dry cell battery holder with the ability to output the total voltage of the installed batteries, even when less than fully populated. Cost is reduced by the absence of holes in the walls of the battery holder case and thereby reducing molding complexity. Cost is also reduced by all battery interconnections being of pre-pre-formed spring temper wire that are installed by snap in and spring back. A non-linear compression pad at the negative end of the battery improves shock resistance.

The present patent application is a continuation in part of patent application Ser. No. 11/472,932.

This patent application incorporates items from pending patent application Ser. No. 11/213,029.

### BACKGROUND OF THE INVENTION

1. Field of the Invention

2. Description of the Prior Art

It can be appreciated that battery holders have been in use for years. Typically, battery holders are pre-determined to accommodate a given number of batteries and are susceptible to intermittent voltage in shock and vibration.

The main problem with conventional battery holders is that the absence of even one battery breaks the serial chain and no voltage at all is available at the battery holder output terminals.

Another problem with conventional battery holders is that extra operations are required for assembly in the subsequent installation of contact terminals and interconnections.

Another problem with conventional battery holders is that battery retention is dependant upon covers or the outside two batteries being partially covered by a retainer. Retaining straps are available but are less retentive on the batteries remote from the outside walls.

Another problem with conventional battery holders is that the removal of batteries generally requires fingernail extracting rather than being pressed out.

Another problem with conventional batter holders is that molding costs of the battery holder case are increased by the requirement for holes in the battery holder case walls.

Another problem with conventional battery holders is that when exposed to shock and/or vibration, battery movement can intermittently open even one circuit in the battery chain resulting in the problem stated above in paragraph 0004.

Another problem with conventional battery holders is the expense incurred in complex molding operations, contacts installation and wiring interconnects.

Another problem with conventional battery holders is that when used to supply power to an Electrostatic Discharge sensitive circuit, removal of the battery, or batteries, leaves the circuit input open circuit and Susceptible to Electrostatic Discharge, ESD, damage.

Another problem with prior art battery holders is that they are limited in output voltage to the total voltage of the totally populated battery holder.

While these devices may be suitable for the particular purpose to which they address, they are not as suitable for the provision of a battery holder that provides economy of production and reliable output voltage as a function of the number of batteries installed.

In view of the disadvantages inherent in the known types of battery holders now present in the prior art, the present invention provides a new and less expensive UNINTERRUPTABLE BATTERY HOLDER with incremental voltage, capable of more reliable service under extreme acceleration movement conditions. It has many of the advantages of the holders mentioned heretofore and many novel features that result in a new ruggedized incremental and selectable voltage battery holder which is not anticipated, rendered obvious, suggested, or even implied by any of the prior art, either alone or in any combination thereof.

### SUMMARY OF THE INVENTION

My battery holder may be considered uninterruptible as the loss of one battery drops the supplied voltage by only the voltage of that one battery. The battery holder is comprised of an injection molded battery holder case containing no holes in the walls, thereby reducing the molding operation to one male and one female mold only. The said holder is able to do this by the use of my invented battery contact and interconnect of pre-formed wire, or stamped metal strip, disposed into positioning retainers molded into the battery holder case 30 and possibly captured by heat staking, spring back or other means.

A given battery is electrically entered into the serially connected battery array by the interconnecting pre-formed wire being contiguous with the positive end of the prior battery and with the negative end of said given battery, which eliminates the need for wall mounted interconnects.

The subsequent battery pre-formed wire forms a normally closed contact with this pre-formed wire that bypasses said given battery position in the event no battery is installed in that position. Each battery position may or may not contain a battery and thereby the serial chain can provide output voltage as a function of the sum of number of batteries present and the voltage of each.

For example, a battery holder of four battery positions can actually supply 14 output voltages by mixing and/or removing 1.5 volt and 1.2 volt batteries.

Shock induced intermittent contact separation protection is increased by the inclusion of my patent pending self-expanding, but resistant to sudden collapsing, bubble.

Shock induced intermittent contact protection is made less critical by the reduction of the severity of losing only 1/n (where “n” is the number of batteries in the chain) of the total voltage as opposed to losing the total voltage.

Battery retention is enhanced by the inclusion of a path for an optional over battery strap, which secures each battery to its adjacent battery case walls.

The general purpose of the present invention, which will be described subsequently in greater detail, is to provide a new incremental voltage battery array holder that has many of the advantages of the holders mentioned heretofore and many novel features that result in a new battery holder which is not anticipated, rendered obvious, suggested, or even implied by any of the prior art, either alone or in any combination thereof.

For the purpose of demonstration of battery economy from experimental results, assume an AA battery costs $1.00.

For an incandescent bulb rated 6 volts:
At 4 batteries, the bulb consumes 0.355 amps at 5.93 volts. Rated life of the 4 batteries is 3.5 hours (Ray-O-Vac Corp). Cost for 4 batteries is $4.00/3.5=$1.14 per hour.
At 3 batteries, and still quite bright, the bulb consumes 0.304 amps at 4.47 volts. Rated battery life is: 5.5 hours. Cost of 3 batteries is $3.00/5.5=$0.55 per hour.
A prior art 4 cell holder would require a 4.87 ohm resistor to drop the voltage to 4.47 volts and 0.304 amps, while still using 4 batteries. Cost is $4.00/5.5=$0.73 per hour plus the resistor cost.
My holder with 2 cells, a soft glowing light, at 0.237 amps and 2.91 volts is rated 7.5 hours or $2.00/7.5=$0.27 per hour.
A prior art 4-cell holder would cost $4.00/7.5=$0.53 per hour plus a 12.7-ohm resistor.
(Powering a 5VDC fan yields even more striking results with less noise).

There has thus been outlined, rather broadly, the more important features of the invention in order that the detailed description thereof may be better understood, and in order that the present contribution to the art may be better appreciated.

In this respect, before explaining at least one embodiment of the invention in detail, i.e. a four battery holder, it is to be understood that the invention is not limited in its application to the details of construction and to the arrangements of the components set forth in the following description or illustrated in the drawings. The invention is capable of other embodiments and have being practiced and carried out in various ways. Also, it is to be understood that the phraseology and terminology employed herein are for the purpose of the description and should not be regarded as limiting.

This invention may be embodied in the form illustrated in the accompanying drawings, attention being called to the fact, however, that the drawings are illustrative only, and that changes may be made in the specific construction illustrated. It is assumed that the pre-formed wire is approximately 0.035 diameter, square or rectangular spring temper metal. The length of wire required per battery is less than the length used for that battery's coil spring of prior art battery holders.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is the schematic of each battery position when no battery is present.

FIG. 2 is the schematic of each battery position when a battery is present.

FIG. 3 is the schematic of a battery holder of 6 positions when only two batteries are present.

FIG. 4 illustrates a battery in position and displacing my positive contact 50 away from being contiguous with the subsequently contiguous pre-formed wire 50.

FIG. 5 illustrates the absence of a battery in position and my pre-formed wires 50 form a bypassing circuit 20, bypassing that battery position.

FIG. 6 is an isometric view of pre-formed wire contacts 49,50 and 51 before installing into a four-battery holder.

FIG. 7 is my reduced cost battery holder 10 with my pre-formed wire contacts 50 installed.

FIG. 8 is a four-battery holder with a retaining strap woven over each battery, securing them to the battery case.

FIG. 9 is a four battery holder with one battery removed from service by being urged away from that positive portion of the pre-formed wire by the insertion of the “OFF” device 200.

FIG. 10 is a cross section of my self expanding bubble showing the one vent hole as described in my patent pending Ser. No. 11/213,029.

FIG. 11 graphs the difference between a normal rate of compression verses a shock rate deflection of the bubble of FIG. 10.

FIG. 12 the bubble of FIG. 10 is used to resist sudden movement of a battery away from the positive pre-formed wire.

FIG. 13 shows by graph how the output voltage of a prior art four-battery holder can go to zero during shock acceleration impact.

FIG. 14 shows by graph how the output voltage of a my invented batter holder can drop to probably greater than zero volts during a shock or vibration acceleration impact.

FIG. 15 shows by graph how the output voltage of my invented batter holder can be smoothed to a lesser voltage variation during shock or vibration impact acceleration by use of an output capacitor.

FIG. 16 is a four-battery holder with a fifth position added for the accommodation of a smoothing capacitor as described in FIG. 15.

FIG. 17 is effectively the schematic of the battery holder of FIG. 16.

### INDEX TO ITEM NUMBERS

10—The basic battery holder case assembly complete with all battery contact wire pre-forms and ready for battery installation.
20—The Normally Closed connection between two pre-formed wires.
30—The molded battery case with no attachments.
49—A specially pre-formed wire used as the positive battery connection of battery “A”.
50—The basic pre-formed wire that conducts electrical current from the negative terminal of a battery to the positive terminal of the next battery.
1—Partial of wire number 50 conducting current from the negative of battery “D” to external usage.
70—Finger access holes in the bottom of battery holder case, item 30 for battery ejection.
75—Recess gaps in the walls for battery retaining straps to pass below the walls.
80—Recess in each wall for the pre-formed wire to pass through en route to the next battery.
90—Pre-formed wires guide molded into case 30 to position and retain pre-formed wires, 49, 50 and 51.
100—A basic cylindrical battery such as, but not limited to an “AA” size.
100 (OFF)—A battery 100, that has been moved longitudinally away from the positive portion of the pre-formed wire contact and is no longer in the serial circuit.
130—My invented self-expanding but resistant to sudden compression bubble per cited pending application.
140—Foam contained in bubble to cause maximum inflation to available confines of skin or installation.
150—A flexible but non-stretchable skin enclosing foam.
160—A small air leak in bubble 130.
170—Resistance to compression curve by bubble undergoing normal battery insertion.
180—Installed point of bubble during normal service.
190—Resistance curve very firm when a high acceleration shock force tries to rapidly move the battery longitudinally away from the positive contact and toward the bubble. A bubble can be installed at the positive end of the battery 100 but must not interfere with the operation of contacts 20.
200—Plastic clip or device that slides onto wall of battery case 30,and disposes battery number 100 (OFF) away from the positive portion of pre-formed wire contact 50, allowing closure of the bypassing contact 20 and thereby removing said battery from the serial circuit.
210—A capacitor occupying a space in the battery holder case 30, connected across the battery holder output terminals and smoothing output voltage of assembly 10 during intermittent contact separation from batteries.
220—alternate configuration using a single pole-double throw switch or relay.

### DESCRIPTION OF THE PREFERRED EMBODIMENT

Turning now descriptively to the drawings, in which similar reference characters denote similar elements throughout the several views, the attached figures illustrate a battery holder of optional quantity of batteries with reduced manufacturing costs and ruggedized for military and industrial applications.

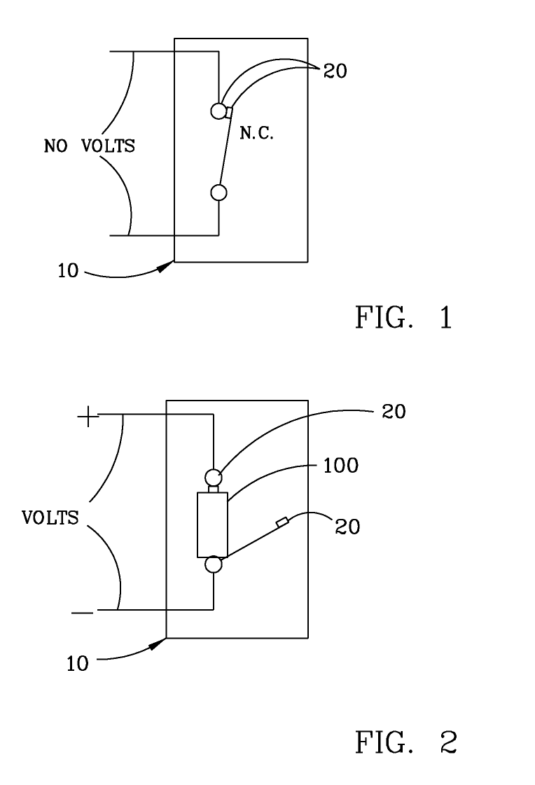

FIG. 1 depicts the schematic of a single battery holder 10 in the absence of an installed battery. Item 20 is a Normally Closed contact that is closed, thereby bypassing the battery position.

FIG. 2 depicts the schematic of a single battery holder in the presence of an installed battery 100. Item 20 has been forced open, by the presence of the installed battery 100 thereby deleting conductivity across the battery position. At this time battery voltage appears across the battery position and its voltage is added to the total voltage of the battery holder 10.

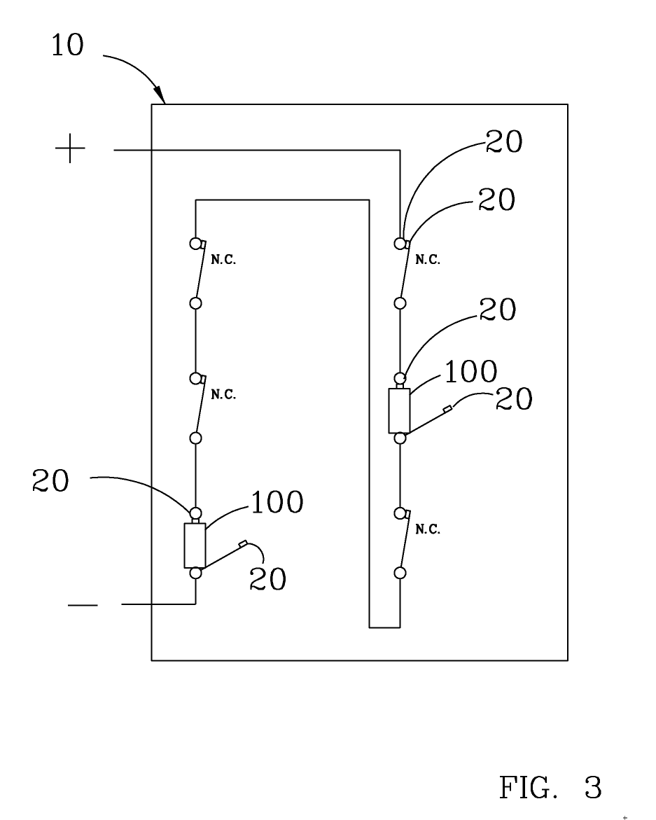

FIG. 3 is a 6-position battery holder 10. A battery 100 is installed in two random positions. Output voltage of the array is the sum of the two batteries due to the normally closed, N.C. contacts passing current through unused positions.

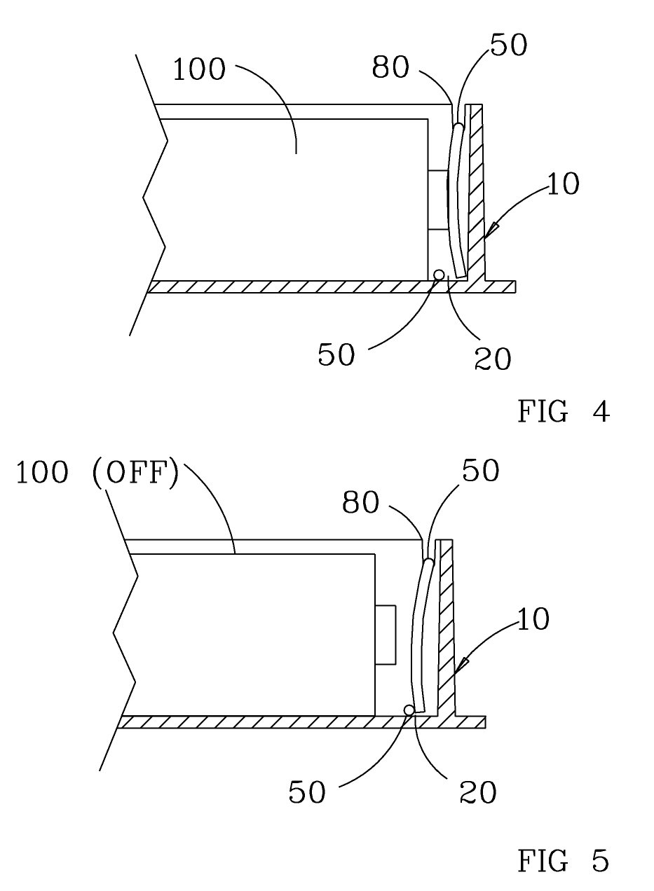

FIG. 4 is a cross section of the battery holder 10, showing how the presence of a battery 100 has opened the circuit at 20 so that the pre-formed wire 50 of positive contact with battery 100 is no longer contiguous with the wire 50 from the negative of the previous battery. Without this bypassing current path, the voltage of the battery 100 is contributed to the voltage of the total serial array. Item 75 is a recess in the battery case 30 walls between battery shown and adjacent battery through which 50 passes.

FIG. 5 is a cross section of the battery holder 10, showing how the movement, or removal of battery 100 removes it from service 100 (OFF) and it no longer contributes its voltage to the serial array. N.C. contact 20, is now closed, thereby connecting the negative of the previous battery to the positive of the subsequent battery. With this current path, the voltage of the battery 100 is bypassed and does not contribute to the voltage of the total.

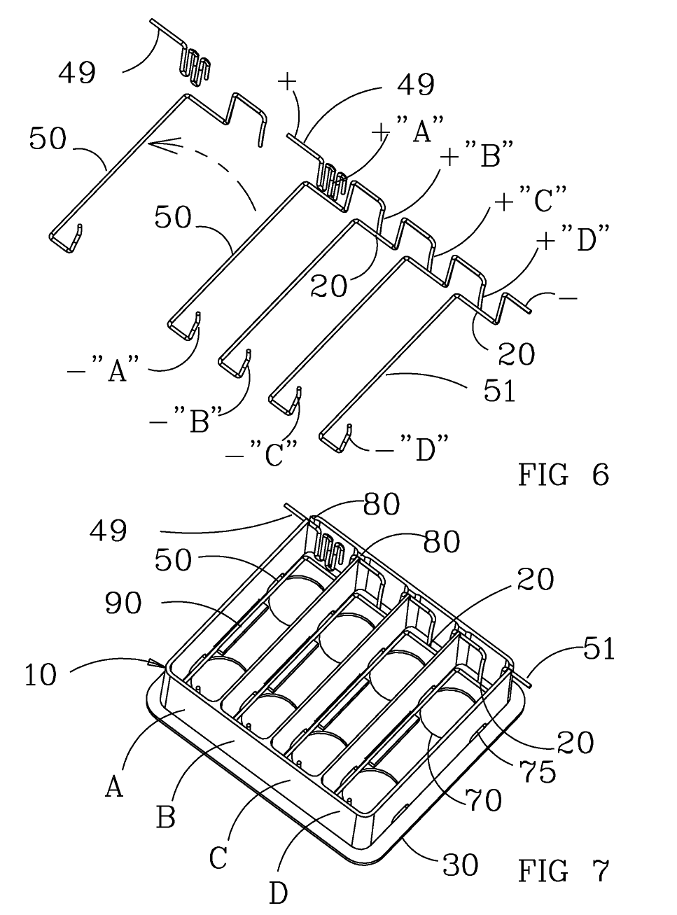

FIG. 6 shows the basic interconnecting pre-formed wire 50 that typically connects the negative end of battery “A” to the positive end of battery “B”. Said pre-formed wire is available at 20 for conduction, in the absence of battery “B”, to the positive end of battery “C”. Wire 49 connects only to battery “A” positive with the opportunity for conduction to pre-formed wire 50 in the absence of battery “A”.

Pre-formed wire 51 is the same as wire 50 but with the next positive position removed. This wire conducts from the negative of battery “D”, or others, to outside usage of the battery holder as the negative terminal. These outputs can be directed downward for installation onto a printed wiring board.

FIG. 7 shows the battery holder case 30, with pre-formed wire 50 positioning channels 90. Also shown are finger holes 70, for battery removal. These holes are extended into slots 75 in the bottom of the walls for lacing 110 the batteries into place. The pre-formed wires 50 are disposed into the receiving channels whereupon they are secured into position possibly by heat staking, spring back into retainers or bonding into the channels. Note there are no holes required in the walls of the battery holder case 30, greatly simplifying molding and final assembly.

The positive contact of battery “A” 49 is configured to accommodate securing into the battery holder case 30 and provides the positive voltage output of the battery holder 10. Battery contact wire 51 is a partial Pre-formed wire 50 and provides the negative output of the battery holder 10. The flanged extended bottom is optional for mounting the battery holder assembly.

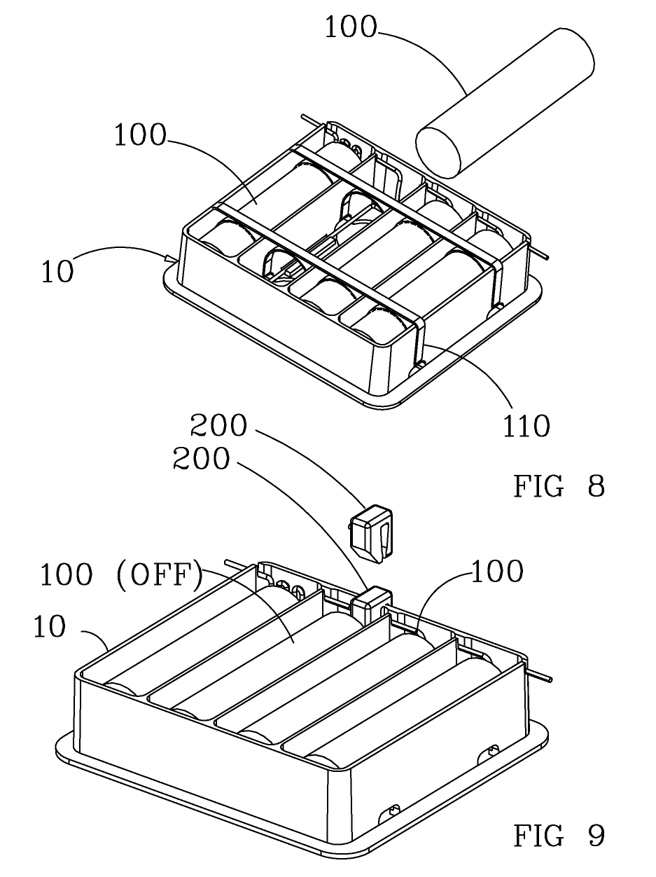

FIG. 8 shows a four-battery holder with the batteries 100, secured by ribbon 110. This ribbon can be a “Tie Wrap”, self-bonding tape such as Velcro tape, elastic ribbon or other. One battery 100 is removed for illustration but the ribbon would not retain shape at that battery position unless ribbon was installed with that battery absent.

If it is not desired to use the ability to slide a battery away from the positive wire 50 in order to turn it off, the inside planar surface of the battery holder case 30, can be coated with a high friction material such as 3140 RTV from DOW CORNING. It will flow off the surface, leaving a thickness of less than 0.010 inches thick with very high frictional characteristics to aid retention in high acceleration forces environments.

FIG. 9 shows an optional “OFF” clip device 200, which when inserted onto the wall of 10, moves that battery 100 (OFF), toward its negative terminal and away from its positive contact as shown in FIG. 5. The battery is now out of the circuit and that battery position is electrically bypassed.

Note that an “OFF” clip 200 at each of all battery positions renders the battery holder assembly 10 electrically off and its outputs are shorted together. A side rail could be added to the molded case 30 that would store one clip 200 per battery for use as desired.

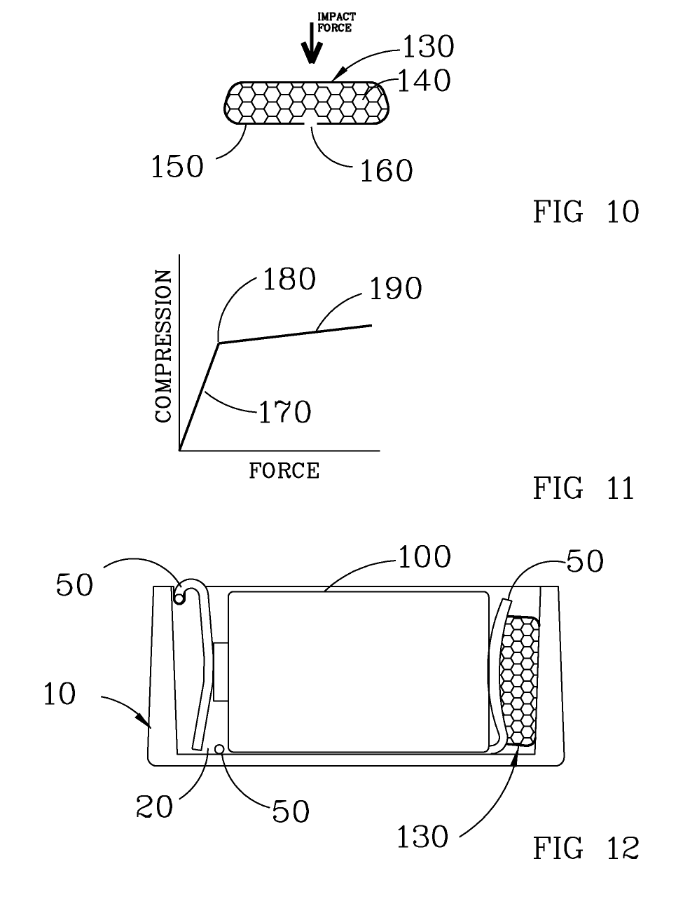

FIG. 10 is an illustration of my shock resisting bubble 130 per pending application Ser. No. 11/213,029. The basic bubble is similar to commercially available packaging bubbles except it contains resilient foam for self-expansion and a small vent hole 160 to allow bubble expansion to fill available confining volume.

FIG. 11 is a LOAD-DEFLECTION graph showing bubble compressibility at a normal rate 170. It is assumed that an installed battery per FIG. 12 brought the bubble to point 180. A sudden high acceleration shock force tending to compress the bubble more finds the vent hole too small to rapidly exhaust the contained air and therefore the bubble presents a high resistance to greater compression 190 thereby preventing the battery from separating from 50 at the positive end.

FIG. 12 shows the bubble 130 installed at the negative end of a battery 100 in a battery holder assembly 10. The bubble will supply high resistance to sudden battery movement away from the faying surfaces between the positive terminal of battery 100 and the pre-formed wire 50. Due to the venting of the bubble, changes in air pressure, such as altitude, does not inflate or deflate said bubble, moving it away from graph point 180 and it stays ready for shock protection.

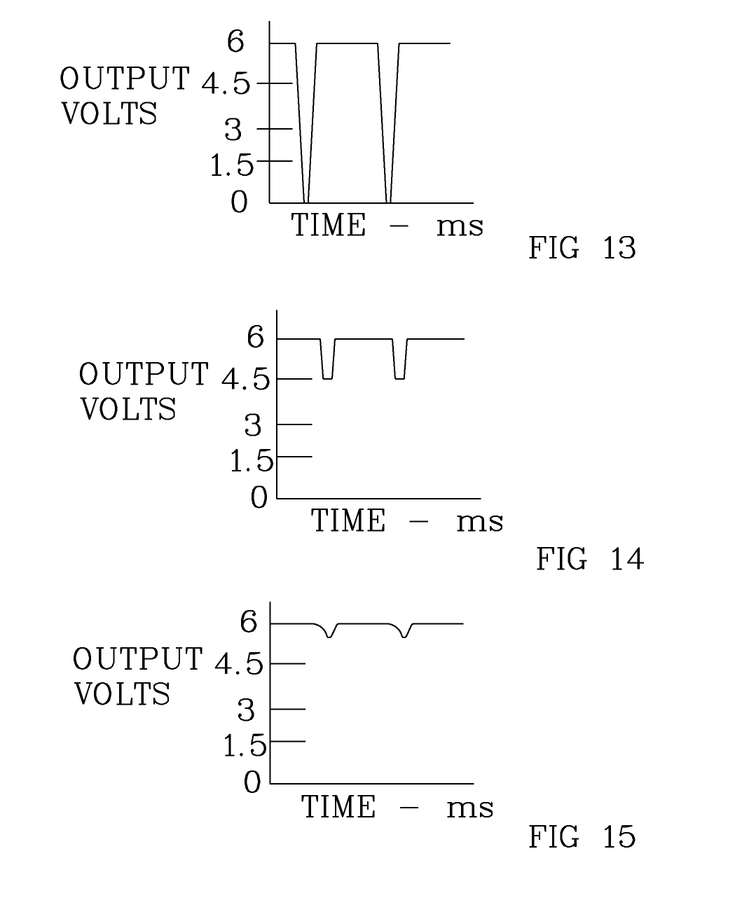

FIG. 13 is a graph of voltage output of a prior art four battery holder when experiencing high acceleration shock or vibration forces. When faying surfaces of battery terminals and battery holder contacts separate, output voltage of the battery box drops to zero. This could be damaging or cause operation difficulty in the device using this supplied power.

FIG. 14 is a graph of my invented battery holder showing that the loss of one or two batteries does not totally stop the flow of all supplied current. It is assumed that statistically not more than one battery would be lost at any given instant. Probably the consuming device could accept the resulting varying direct current from the supply.

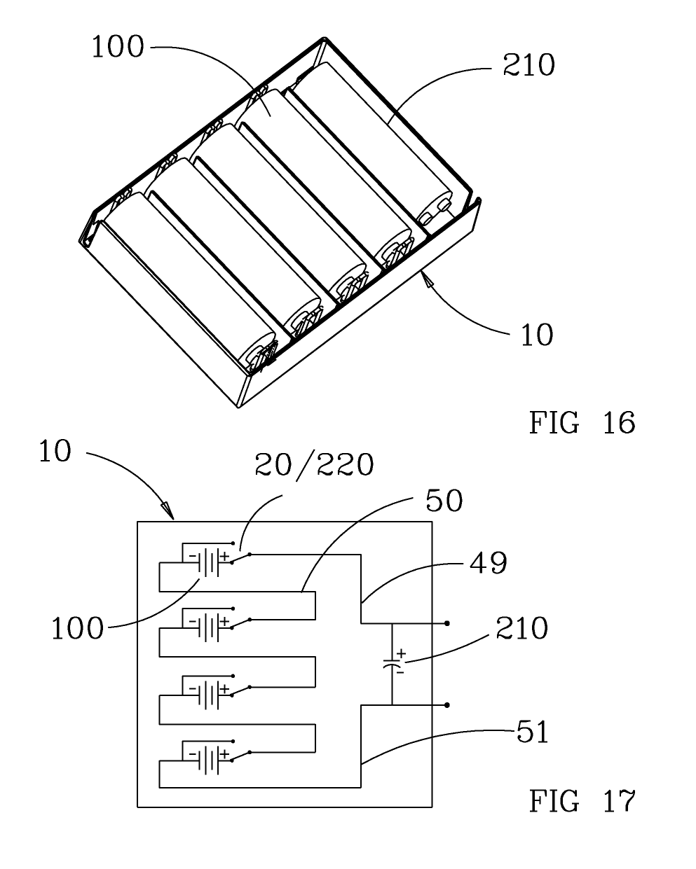

FIG. 15 it is assumed that the battery holder output is parallel connected with a large capacitance that lessens the amount of voltage variation delivered to the using device during high acceleration loads. See FIG. 16.

FIG. 16 is a battery holder assembly 10 with an added space for installation of a large capacitor 210 that can be incorporated parallel connected across the battery output as shown in FIG. 17. Output voltage of this battery holder assembly should be highly reliable and low noise.

FIG. 17 is the schematic of a four-battery holder assembly 10 with the additional output capacitor 210 of FIG. 16. The alternate to battery actuated bypassing contacts 20, 220 is shown as a switch for each battery.

I claim:

1. Prior art of battery holders generally consist of a plastic molded case of two parts, wall mounted contacts, wall mounted coil springs and interconnecting wiring to each wherein my improvements comprise
a simplified molded battery holder case having no holes in the walls and being of single part construction with a plurality of cylindrical battery positions and
a plurality of pre-formed wires contiguous with and interconnecting said batteries in a serial circuit

2. said pre-formed wires of claim 1 are disposed in retaining features molded into said holder case of claim 1.

3. said pre-formed wires of claim 1 have a cross section being round, square or rectangular and of sufficient size to provide ample rigidity for reliable electrical contact to said batteries contained in the said battery holder of claim 1.

4. said pre-formed wires of claim 1 may be nickel plated and may be spot, or continuous, plated with hard gold at battery faying surfaces for lessened contact resistance.

5. pairs of said pre-formed wires of claim 1 are contiguous at a given said battery position to provide an electrical path from a previous battery position to the following battery position in the absence of said battery.

6. said case of battery holder of claim 1 is of reduced cost by reduction in mold complexity and the absence of wall mounted contacts and interconnecting wiring.

7. the major planar sheet of now single part said battery holder case of claim 1 may extend beyond the walls as desired thereby providing ease of battery holder mounting.

8. said batteries of claim 1 can be optionally secured in said holder case of claim 1 by a provided path for over and under ribbon weaving thereby securing each battery to its adjacent walls.

9. said holder case of claim 1 has finger size access holes in the major planar sheet to assist in battery ejection from said holder.

10. said batteries of claim 1 may be restricted from movement under high acceleration shock forces by a compression resistant shock bubble disposed at one or both ends of said batteries.

11. said battery holder of claim 1 may have a provided space for a capacitor able to be connected to the voltage output of said battery holder in order to reduce output voltage variations from intermittent contact separations resulting from shock or vibration.

12. individual said batteries of claim 1 may be singularly removed from service by a device that urges said battery away from said formed wire contact of claim 1.

13. the positive and negative output terminals of said battery holder of claim 1 are electrically connected one to the other when all batteries are removed thereby protecting a powered electrostatic discharge, ESD, sensitive circuit from induced static electricity damage.

14. An alternate means for selection of individual batteries in a battery holder or on a printed circuit board for incorporation or deselected and by-passed into the total voltage output of said battery serially connected circuit can be by a single pole, double throw switch or relay for each battery.
